(19) United States
(12) Patent Application Publication
(10) Pub. No.: US 2013/0333800 A1
(43) Pub. Date: Dec. 19, 2013

(54) SYSTEM AND METHOD FOR FILLING A CONTAINER WITH A POURABLE PRODUCT

(71) Applicant: Enrico Cocchi, Parma (IT)

(72) Inventor: Enrico Cocchi, Parma (IT)

(73) Assignee: SIDEL S.P.A. CON SOCIO UNICO, Parma (IT)

(21) Appl. No.: 13/995,344

(22) PCT Filed: Dec. 19, 2011
(86) PCT No.: PCT/IB11/55795

§ 371 Date: Aug. 29, 2013

(30) Foreign Application Priority Data
Dec. 23, 2010 (IT) TO2010A001052

(51) Int. Cl. B67C 3/00

(52) U.S. Cl. CPC B67C 3/007
USPC 141/192

(57) ABSTRACT

There is disclosed a filling system for filling a container with a pourable product, in particular a pourable product having an electrical conductivity below 15 μS, comprising: a tank filled, in use, with a pourable product; at least one filling valve selectively available in a configuration in which it allows the filling of the container with the pourable product; and at least one duct interposed between the tank and the filling valve; the system comprises a vortex flowmeter interposed along the duct.

### TECHNICAL FIELD

The present invention relates to a system and method for filling a container with a pourable product.

In particular, the present invention relates to a system and method for filling a container with a pourable food product.

More in particular, the present invention relates to a system and method for filling a container with a pourable food product having an electrical conductivity below 15 μS, for example osmotised water i.e. water subjected to an inverse osmosis process to reduce the concentration of dissolved salts as much as possible.

### BACKGROUND ART

Filling systems incorporated in bottling machines and defining respective filling stations are known.

More precisely, the filling station is fed with empty containers and provides containers filled with the pourable food product.

The filling station substantially comprises a carousel conveyor rotating about a rotation axis, a tank containing the pourable food product and positioned on the carousel or externally thereto, and a plurality of filling valves which are fluidically connected with the tank and are supported by the carousel conveyor in a radially external position with respect to the rotation axis of the carousel conveyor.

In greater detail, the valves are displaceable between respective open positions in which they allow the flow of pourable product within the respective containers, and respective closed positions in which they prevent the pourable product from flowing within the respective containers.

The carousel conveyor is provided with a plurality of support elements for the containers provided to arrange container filling mouths in positions below the respective valves and handle the containers along an arc-shaped path about said rotation axis integrally with the respective valves.

The tank is fluidically connected with the filling valves by means of a plurality of ducts, along each of which magnetic flowmeters are interposed to measure, when the respective filling valves are arranged in open positions, the flow rates of fluid by which the containers are filled.

The measurement of the flow rate performed by the magnetic flowmeters is used to control the movement of the filling valves between the respective open and closed positions, so as to fill the containers with a desired amount of pourable food product.

In greater detail, the magnetic flowmeters create a magnetic field in a direction radial to the axis of the duct and detect an output voltage proportional to the speed and, therefore, to the flow rate of the pourable product.

More precisely, the pourable product has an own electric conductivity, substantially due to the fact that it contains dissociated ions, and therefore gives rise to electric currents when it passes through the magnetic field generated by the electric conductivity flowmeter.

These currents are detected by means of a voltage measurer, which inevitably varies the measurement of the flow rate performed by the flowmeter mainly due to its internal resistances generating a measurement error.

Recently, the need has developed in the sector for containers filled with osmotised water, i.e. water substantially free of dissolved salts and having a very low electric conductivity, for example lower than 15 μS.

The Applicant has noted that when the electric conductivity of the pourable product reaches such low values, the measurement error introduced by the magnetic flowmeter in the measurement of the flow rate is particularly relevant and sometimes on the same order of magnitude of the flow rate.

Therefore, the measurement of the flow rate performed by the flowmeter results in these cases poorly reliable, generating problems in the precision and in the repeatability of the filling of the container.

The need is felt for measurements of the flow rates of pourable products with especially low electric conductivity, such as for example osmotised water, in a simple and cost-effective manner and reducing the presence of mobile parts as much as possible.

### DISCLOSURE OF INVENTION

It is an object of the present invention to provide a filling system to fill a container with a pourable product, which allows to satisfy the above said need in a simple and cost-effective manner.

The above said object is achieved by the present invention as it relates to a filling system of a container with a pourable product, in particular a pourable product having an electric conductivity below 15 μS, according to claim 1.

The present invention also relates to a method for filling a container with a pourable product, in particular a pourable product having an electric conductivity below 15 μS, according to claim 10.

### BRIEF DESCRIPTION OF THE DRAWINGS

A preferred embodiment is hereinafter disclosed for a better understanding of the present invention, by mere way of non-limitative example and with reference to the accompanying drawings, in which:

FIG. 1 diagrammatically shows a system for filling containers with pourable products made according to the dictates of the present invention;

FIG. 2 shows an enlarged exploded view of some components of the system of FIG. 1;

FIG. 3 shows another detail of FIG. 2 in a particularly enlarged perspective view; and

FIG. 4 shows a particularly enlarged view of some details in FIG. 2.

### BEST MODE FOR CARRYING OUT THE INVENTION

With particular reference to the accompanying figures, numeral 1 indicates a filling system for filling containers 2 with a pourable product and adapted to be incorporated in a filling machine which is not shown in detail.

In greater detail, the pourable product has an electric conductivity lower than 15 μS.

More in particular, the pourable product is a food product and could be osmotised water, i.e. water subjected to an inverse osmosis process and therefore substantially free of dissolved salts.

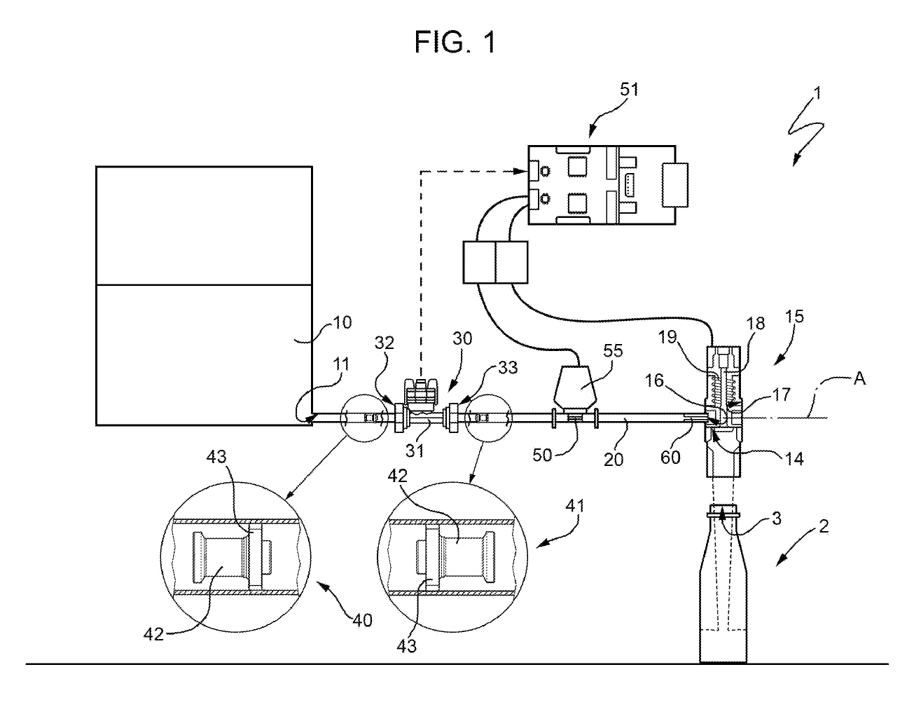

System 1 substantially comprises:
a tank 10 filled with a pourable product at a given pressure, for example at a pressure in the range between 0.6 and 1.4 bars;
a plurality of filling valves 15 (only one of which shown in FIG. 1) adapted to fill respective containers 20 with the pourable product; and
a plurality of ducts 20 (one of which shown in FIG. 1) extending along respective axes A, interposed between an outlet mouth 11 of the tank 10 and an inlet mouth 16 of the corresponding filling valve 15.

Filling valves 15 protrude from a carousel (not shown) that rotates about a vertical axis and forming part of the filling machine.

Filling valves 15 each comprise a hollow housing 17 defining inlet mouth 16 and a shutter element 18 that slides parallelly to the vertical axis within housing 17.

Shutter element 18 of each filling valve 15 may be displaced between a closed position (shown in FIG. 1) in which it prevents pourable product from flowing from respective duct 20 to respective container 2 by means of an opening 14, and an open position in which it allows the pourable product to flow from respective duct 20 to respective container 2.

Each filling valve 15 further comprises a spring 19, in this case a helicoidal spring having a vertical axis, interposed between shutter element 18 and housing 17. In particular, each spring 19 is wound on respective shutter element 18 and loads respective shutter element 18 towards the open position.

Containers 2 are also rotated integrally with the carousel conveyor during a filling step, so that respective mouths 3 are arranged below respective filling valves 15.

Advantageously, system 1 comprises a plurality of vortex flowmeters 30 interposed along respective ducts 20.

Vortex flowmeters 30 are adapted to detect, when respective filling valves 15 are arranged in respective open positions, the flow rates of pourable product that pass through respective ducts 20, so as to provide respective information associated to the amounts of pourable product by which respective containers 2 have been filled.

In particular, vortex flowmeters 20 exploit the precession of the vortexes of Kalman.

The following disclosure will refer for simplicity to a single duct 20, a single vortex flowmeter 30 and a single filling valve 15.

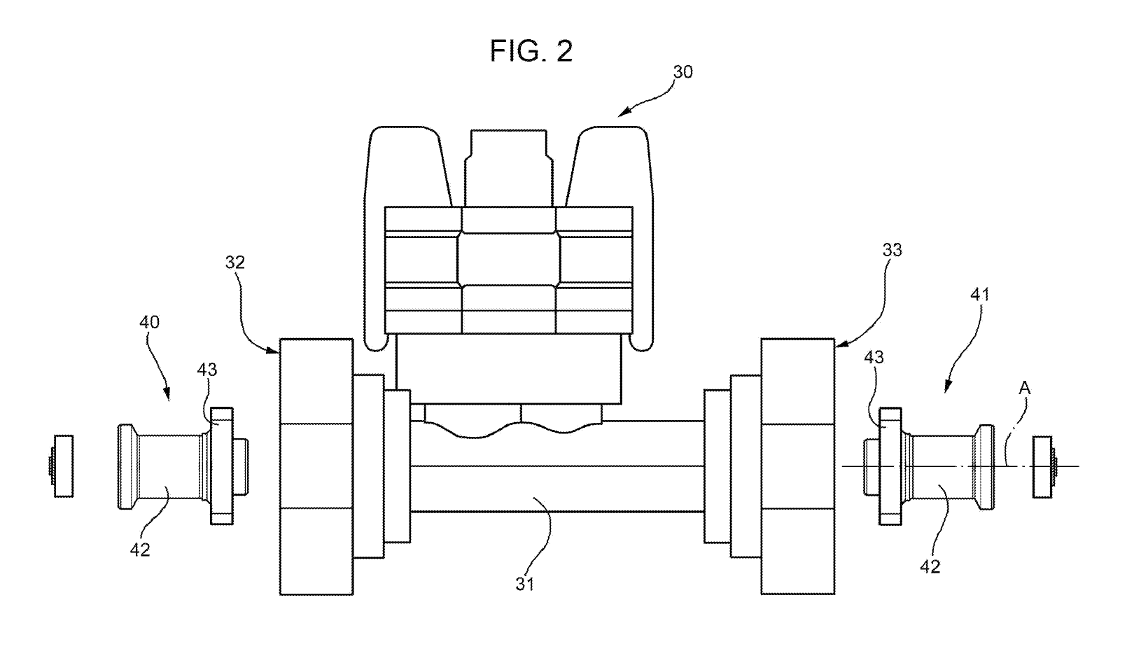

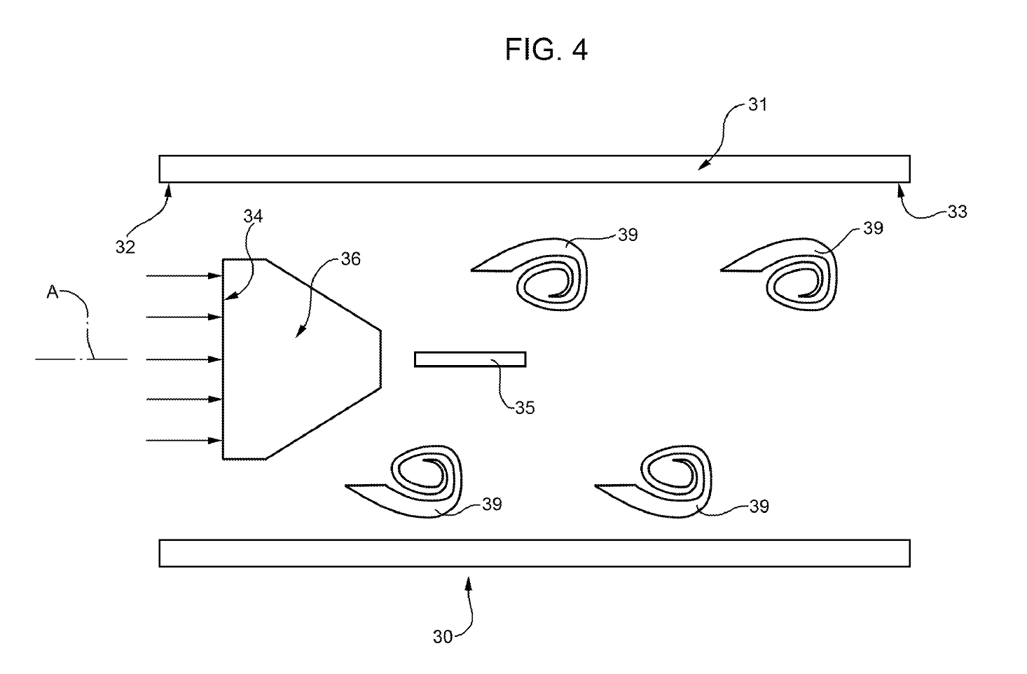

Vortex flowmeter 20 comprises (FIGS. 2 and 4):
a main tubular body 31 defining an inlet mouth 32 and an outlet mouth 33 through which duct 20 passes;
an obstacle 36 having a trapezoidal axial section, inserted in the main body 31 and defining an impact surface 34 orthogonal to axis A of duct 20; and
a sensor 35 arranged downstream of obstacle 36 proceeding from inlet mouth 32 towards outlet mouth 33.

Obstacle 36 extends symmetrically with respect to axis A.

In particular, the pourable product fed in inlet mouth 32 impacts against surface 34 of obstacle 36, producing a train of vortexes 39, the frequency of which is proportional to the speed of the pourable product within duct 20.

Sensor 35 detects the frequency of vortexes 39 and generates an impulsive electric signal associated to this frequency and therefore to the speed and flow rate of the pourable product in duct 20.

System 1 further comprises, proceeding from tank 10 towards filling valve 15 (FIG. 1):
a lineariser device 40 for linearising the flow of the pourable product and arranged downstream of the inlet mouth 32 of the vortex flowmeter 30;
a lineariser device 41 for linearising the flow of the pourable product and arranged downstream of the outlet mouth 33 of the vortex flowmeter 30;
a throttling 50;
a valve 55 displaceable between a first position in which it allows the pourable product to bypass throttling 50 and a second position in which it forces the pourable product to pass through throttling 50; and
another throttling 60 arranged immediately upstream of filling valve 15.

Device 40 is adapted to make the flow of the pourable product as laminated as possible upstream of vortex flowmeter 30. Thereby, the measurement performed by vortex flowmeter 30 is not disturbed by the possible turbulent flow of the pourable product not generated by the impact thereof against obstacle 36.

Device 41 is adapted to make the flow of the pourable product as laminated as possible downstream of vortex flowmeter 30. Thereby, the turbulences of the flow of the pourable product downstream of vortex flowmeter 30 do not disturb the operation of vortex flowmeter 30.

With reference to FIGS. 1 and 2, devices 40, 41 are housed within respective portions of duct 20 arranged respectively upstream and downstream of vortex flowmeter 30.

Each device 40, 41 further comprises:
a main body 42 arranged coaxially to duct 20; and
a disc 43 radially projecting from main body 42, defining a plurality of openings 44 through which a pourable product passes, and having an external diameter thereof cooperating with an inner side surface of duct 20.

Devices 40, 41 are mounted symmetrically with respect to vortex flowmeter 30.

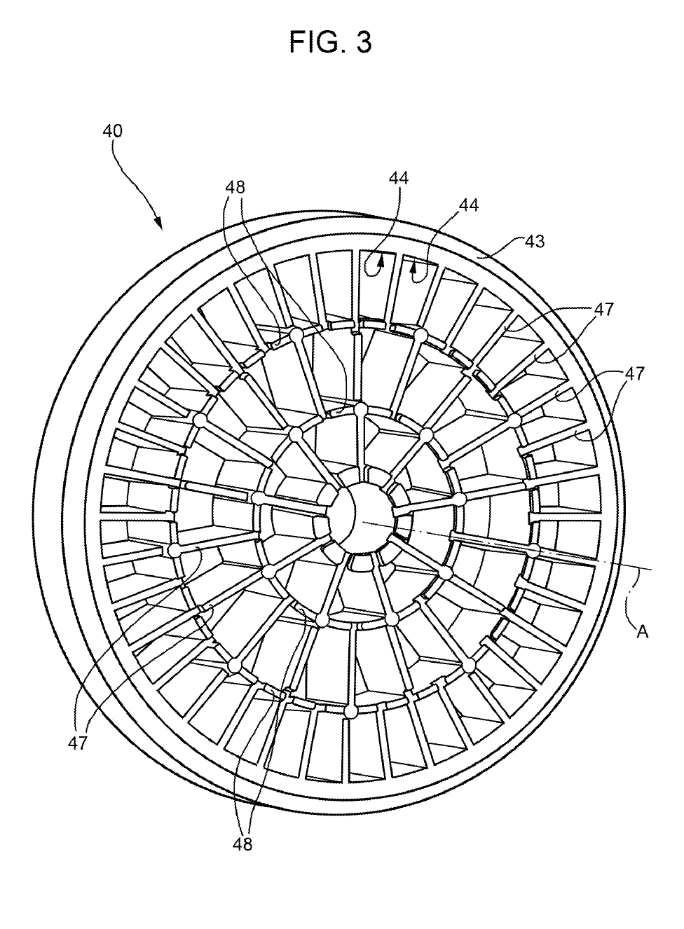

In particular, disc 43 comprises (FIG. 3) a plurality of walls 47 which are radial to axis A, and a plurality of walls 48 configured as circumferences and intersecting walls 47 (FIG. 3).

Each opening 44 is open parallelly to axis A, is radially defined by respective segments of two sequential walls 48 and is defined circumferentially by respective segments of two sequential walls 47.

Discs 43 are arranged near respective axial ends of respective main bodies 42.

More precisely, disc 43 of device 40 is arranged at an axial end of main body 42, which is nearest to inlet mouth 32 of vortex flowmeter 30.

Disc 43 of device 41 is arranged at an axial end of main body 42, which is nearest to inlet mouth 33 of vortex flowmeter 30.

With reference to a condition in which filling valve is in an open position, valve 55 allows a high speed filling when arranged in the first position and a low speed filling when arranged in the second position.

As a matter of fact, when valve 55 is arranged in the second position, the pourable product passes through throttling 50, which reduces the flow rate thereof.

Throttling 60 is adapted to reduce the maximum flow rate fed to filling valve 15 when valve 55 is arranged in the first position, and to increase the pressure downstream of vortex flow meter 30 so as to avoid cavitation phenomena of the pourable product within duct 20.

Throttlings 50, 60 are configured as hollow cylinders coaxial to duct 20.

Preferably, the diameter of throttling 60 is greater than the diameter of throttling 50.

In the case shown, duct 20 and vortex flowmeter 30 are dimensioned so that the pressure at outlet mouth 33 is at least 5 times the hydraulic head of the pourable product between inlet mouth 32 and outlet mouth 33.

More precisely, duct 20 and vortex flowmeter 30 are dimensioned so that the pressure at inlet mouth 32 is at least 5.5 times the hydraulic head of the pourable product between inlet mouth 32 and outlet mouth 33.

System 1 further comprises a control unit 51 inputted with a measurement of the flow rate of the pourable food product detected by vortex flowmeter 30, and adapted to control valve 55 and filling valve 15.

The filling machine comprises the carousel conveyor and a plurality of systems 1.

In a first embodiment, the filling machine comprises a single tank 10 connected to all ducts 20 of respective systems 1 and arranged externally to the carousel.

In a second embodiment, tank 10 is connected to all ducts 20 of respective systems 1 and is arranged internally to the carousel conveyor.

The operation of system 1 is disclosed with reference to a single duct 20, a single vortex flowmeter 30, a single valve 55 and a single filling valve 15.

When container 2 is to be filled, control unit 51 arranges filing valve 15 in the open position.

Furthermore, control unit 51 arranges valve 55 in the first position in case of high speed filling and in the second position in case of low speed filling.

Indeed, in the case of high speed filling, valve 55 moves the pourable product along a path in which it bypasses throttling 50.

Differently, in the case of low speed filling, valve 55 forces the pourable product to pass through throttling 50, determining a reduction in the filling speed of container 2.

The pourable product moves in duct 20 from tank 10 towards filling valve 15, passing through, in a sequence:
device 40:
vortex flowmeter 30;
device 41:
valve 55; and
throttling 60.

More precisely, the flow of the pourable product is made as laminar as possible by device 40, in virtue of the presence of openings 44.

Thereby, possible turbulences of the flow of the pourable product which are not caused by the interaction with obstacle 36 do not disturb the measurement of vortex flowmeter 30.

Subsequently, the pourable product passes through inlet mouth 32 and impacts against obstacle 36 generating vortexes 39 (FIG. 4).

Sensor 35 detects the frequency of vortexes 39 and generates a pourable product flow rate signal proportional to the above said frequency of vortexes 39.

Control unit 51 is inputted with this flow rate signal and uses it to control filling valve 15 and valve 55.

More precisely, control unit 51 controls filling valve 15 and valve 55 so that container 2 is filled with a given amount of pourable product and at a given filling speed.

After having interacted with obstacle 36 and sensor 35, the pourable product passes through outlet mouth 33 and reaches device 41.

In virtue of openings 44, device 41 makes the flow of the pourable product downstream of vortex flowmeter 30 as laminar as possible.

Therefore, possible turbulences downstream of vortex flowmeter 30 do not disturb the measurement of the flow rate performed by vortex flowmeter 30.

Subsequently, the pourable product passes through or does not pass through throttling 50 depending on whether valve 55 is arranged in the second or in the first position.

Downstream of valve 55, the pourable product passes through throttling 60, which is effective in reducing the maximum flow rate passing through valve 55 in high speed filling conditions and maintains at a minimum value the pressure downstream of vortex flowmeter 30, preventing the occurrence of cavitation phenomena within vortex flowmeter 30.

Subsequently, the pourable product passes through inlet mouth 16 and opening 14, and fills container 2.

At the end of the filling step, filling valve 15 is returned to the closed position by spring 19.

From an analysis of the features of system 1 and of the method according to the present invention, the advantages it allows to obtain are apparent.

In particular, system 1, in virtue of the presence of vortex flowmeter 30, allows to measure the flow rate of the pourable product within duct 20 in the step of filling container 2, independently of the electric conductivity of the pourable product.

Indeed, the precision and accuracy of vortex flowmeter are not affected by the electric conductivity of the pourable product, contrary to what happens with magnetic flowmeter discloses in the introduction of the present disclosure.

The consequence is that system 1 allows to fill containers 2 with a high precision even with a pourable product having an electric conductivity below 15 μS, such as for example osmotised water.

Furthermore, in virtue of the fact that vortex flowmeter 30 does not require moving parts, system 1 results particularly cost-effective to implement and simple to maintain.

The presence of devices 40, 41 allows to avoid that possible turbulences of the flow of the pourable product both upstream and downstream of vortex flowmeter 30 disturb the precision of the measurement of the flow rate performed by vortex flowmeter 30.

The consequence is that devices 40, 41 considerably increase the repeatability of the measurement of the flow rate performed by vortex flowmeter 30.

In particular, the configuration of openings 44 symmetrical with respect to axis A allows to make the flow of pourable product inputted in vortex flowmeter 30 symmetrical with respect to axis A.

Thereby, possible distortions generated by dissymmetries in duct 20 do not disturb the measurement of vortex flowmeter 30.

Throttling 60 reduces the maximum flow rate passing through valve 55 in high speed filling conditions and maintains the pressure downstream of vortex flowmeter 30 at a minimum value, avoiding the occurrence of cavitation phenomena within vortex flowmeter 30.

Finally, system 1 comprises a filling valve 15, which is exclusively dedicated to filling container 2 while it employs valve 55 to select the filling speed.

The consequence is that the filling of container 2 is highly repeatable, independently of the speed of the filling.

Finally, it is clear that modifications and variants not departing from the scope of protection of the claims can be made to system 1 and to the filling method disclosed and shown herein.

1. A filling system for filling a container with a pourable product having electrical conductivity below 15 μS, comprising:
a tank, fillable with the pourable product;
at least one filling valve selectively available in a configuration to allow the filling of said container with said pourable product;
at least one duct interposed between said tank and said filling valve; and
a vortex flowmeter interposed along said duct.

2. The system according to claim 1, comprising a first flow lineariser arranged within said duct and upstream of said vortex flowmeter, proceeding from said tank towards said filling valve.

3. The system according to claim 1, comprising a second flow lineariser arranged within said duct and downstream of said vortex flowmeter, proceeding from said tank towards said filling valve.

4. The system according to claim 2, wherein at least one of said first and second flow linearisers comprises a plurality of openings which are symmetrical with respect to an axis of said duct.

5. The system according to claim 1, comprising a first throttling interposed between said vortex flowmeter and said filling valve.

6. The system according to claim 5, comprising:
a second throttling interposed between said vortex flowmeter and said first throttling; and
a bypass valve displaceable between a first position in which it allows to allow said pourable product to bypass said second throttling so as to perform a high speed filling, and a second position to force said pourable product to pass through said second throttling so as to perform a low speed filling.

7. The system according to claim 6, wherein said first and second throttling are cylindrical, and in that the diameter of the first throttling is greater than the diameter of the second throttling.

8. The system according to claim 1, wherein said vortex flowmeter comprises an inlet mouth and an outlet mouth;
said duct and said vortex flowmeter being dimensioned so that the pressure at said outlet mouth is at least 5 times the hydraulic pressure head between said inlet and outlet mouths.

9. A filling machine for filling said container with a pourable product having an electrical conductivity below 15 μS, comprising:
a plurality of filling systems, each comprising:
a tank fillable with the pourable product;
at least one filling valve selectively available in a configuration to allow the filling of said container with said pourable product;
at least one duct interposed between said tank and said filling valve; and
a vortex flowmeter interposed along said duct; and
a carousel conveyor to rotate about an axis and comprising a plurality of said filling valves;
wherein a single tank is arranged outside or inside said carousel conveyor and is fluidically connected to said ducts of respective said systems.

10. A method for filling a container with a pourable product product having an electrical conductivity below 15 μS, comprising the steps of:
filling said container with said pourable product using a filling valve, which is selectively available in a position in which it allows the filling of said container with said pourable product; and
feeding said pourable product contained in a tank via a duct extending towards said filling valve;
wherein said filling step comprises the step of measuring the flow rate of said pourable product using a vortex flowmeter interposed along said duct.

11. The filling method according to claim 10, comprising the step of making the flow of said pourable product laminar upstream of said vortex flowmeter.

12. The filling method according to claim 10, comprising the step of making the flow of said pourable product laminar downstream of said vortex flowmeter.

13. The method according to claim 10, wherein the filling step comprises the step of:
conveying said pourable product in a throttling to fill said container at a low speed; or
conveying said pourable product along a bypass path of said throttling to fill said container at a high speed.

14. The system according to claim 9, comprising a first flow lineariser arranged within said duct and upstream of said vortex flowmeter, proceeding from said tank towards said filling valve.

15. The system according to claim 9, comprising a second flow lineariser arranged within said duct and downstream of said vortex flowmeter, proceeding from said tank towards said filling valve.

16. The system according to claim 14, wherein at least one of said first and second flow linearisers comprises a plurality of openings which are symmetrical with respect to an axis of said duct.

17. The system according to claim 9, comprising a first throttling interposed between said vortex flowmeter and said filling valve.

18. The system according to claim 17, comprising:
a second throttling interposed between said vortex flowmeter and said first throttling; and
a bypass valve displaceable between a first position in to allow said pourable product to bypass said second throttling so as to perform a high speed filling, and a second position to force said pourable product to pass through said second throttling so as to perform a low speed filling.

19. The system according to claim 18, wherein said first and second throttling are cylindrical, and in that the diameter of the first throttling is greater than the diameter of the second throttling.

20. The system according to claim 9, wherein said vortex flowmeter comprises an inlet mouth and an outlet mouth;
said duct and said vortex flowmeter being dimensioned so that the pressure at said outlet mouth is at least 5 times the pressure head between said inlet and outlet mouths.
